(19) United States
(12) Patent Application Publication
(10) Pub. No.: US 2023/0354165 A1
(43) Pub. Date: Nov. 2, 2023

(54) SYSTEM AND METHOD FOR DYNAMIC NETWORK SLICE SUBSCRIPTION AND CREATION

(71) Applicant: Verizon Patent and Licensing Inc., Basking Ridge, NJ (US)

(72) Inventors: Raquel Morera Sempere, Weehawken, NJ (US); Sudhakar Reddy Patil, Flower Mound, TX (US); Ye Huang, San Ramon, CA (US)

(21) Appl. No.: 17/730,889

(22) Filed: Apr. 27, 2022

(51) Int. Cl. H04W 48/16; H04W 48/18; H04W 8/18

(52) U.S. Cl. CPC H04W 48/16; H04W 48/18; H04W 8/183

(57) ABSTRACT

A device may include a processor configured to: receive a request from a network function for establishing a session for the network function and a User Equipment device (UE); obtain an identifier corresponding to a network slice for providing the session; update the subscriber data with the network slice identifier; and set up the session, for the network function from the UE to the network slice.

### BACKGROUND INFORMATION

Advanced wireless communication service providers today may have the capability to provide particular services to their customers by using network slices that comprise different types of virtual network components. For example, a network slice may include a virtual machine or a container. A virtual machine may include hardware, a hypervisor to manage emulation of an abstracted version of a computer, and an operating system. For a virtual machine, hardware may be virtualized. A container is a program that is run by a container engine, which in turns runs on an operating system. For containers, the operating system may be virtualized.

### BRIEF DESCRIPTION OF THE DRAWINGS

FIG. 1 illustrates an overview of an exemplary system for supporting dynamic network slice subscription and creation, according to an implementation;

FIG. 2 illustrates an exemplary network environment in which the systems and methods for supporting dynamic network slice subscription and creation may be implemented;

FIG. 3 depicts exemplary components of a portion of network according to an implementation;

FIGS. 4A and 4B show a flow diagram of an exemplary process that is associated with the systems and methods for supporting dynamic network slice subscription and creation, according to an implementation;

FIGS. 5A and 5B show signaling diagrams of an exemplary process that is associated with the systems and methods for supporting dynamic network slice subscription and creation, according to an implementation; and

FIG. 6 depicts exemplary components of an exemplary network device according to an implementation.

### DETAILED DESCRIPTION OF EMBODIMENTS

The following detailed description refers to the accompanying drawings. The same reference numbers in different drawings may identify the same or similar elements.

The systems and methods described herein relate to providing support for dynamic network slice subscription and creation. When a User Equipment device (UE) (e.g., a smart phone) that is attached to a wireless network requests the network to establish a protocol data unit (PDU) session, for the network to grant the request, the network needs to associate the request to a particular network slice. A network slice may be a logical network that is identified by a Single-Network Slice Selection Assistance Information (S-NSSAI). For the network to make the association, the S-NSSAI needs to be included with the subscription data for the UE, in particular, in the list of network slices to which the UE may connect. If the request is for establishing a session with an application server (herein simply referred to as application) and the application sponsors data needed for the session on a network slice (referred to as a sponsored slice or sponsored S-NSSAI), the session has to be associated with the sponsored S-NSSSAI and the sponsored S-NSSAI has to be included in the subscription data.

In some situations, however, the subscription data for the UE may not include the S-NSSAI for the sponsored network slice (which is identified by the sponsored S-NSSAI) and the sponsored S-NSSAI may not be in the list of S-NSSAIs (which identify the network slices that the UE may access) in the subscription data (e.g., subscription profile). If the sponsored S-NSSAI is not included in the subscription data, the network may not allow the UE to connect to the sponsored network slice. Since network slices may be dynamically created for or assigned to the application, it may not be possible for the network to know, prior to the session request, to which network slice the UE should be subscribed. For the network to enable the session, the network needs to create, using the subscription data, an association between a requested UE session and a sponsored network slice. If the S-NSSAI for the sponsored network slice is not in the list of subscribed S-NSSAIs, the network may be unable to make the association and grant the session request.

Within a Fifth Generation (5G) network, a User Data Management (UDM) function manages UE subscription data. Although a typical UDM may expose what is known as a parameter provisioning service that enables a consumer network function (e.g., a network component that uses services offered by another network component) to modify the subscription data, the parameter provisioning service does not currently permit an addition or a removal of a S-NSSAI from the subscription data. Without the ability, a sponsored S-NSSAI that is not in the subscription data may not be added to the subscription data and thus become identifiable for the association. Consequently, the UE would be unable to connect to the sponsored network slice. The systems and methods described herein overcome the limitations of the parameter provisioning service and permit addition of an S-NSSAI, for a newly created network slice, to the subscription data, as well as a mechanism for creating the new network slice. That is, the systems and methods described herein provide support for dynamic network slice subscription and creation, to enable UEs to connect to sponsored network slices.

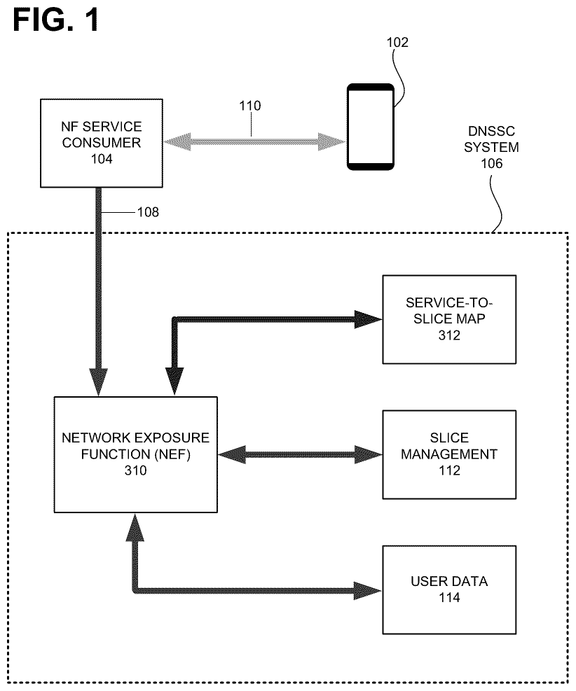

FIG. 1 illustrates an overview of a system for supporting dynamic network slice subscription and creation (DNSSC) 106, according to one implementation. As shown, DNSSC system 106 may receive a request 110 regarding a particular subscription profile from a network component, generically referred to as a Network Function (NF) service consumer 104. NF service consumer 104 may send the request 108 as a result of a UE 102 establishing a signaling path 110 through many network devices and/or components and sending control signals over the path 110. One of the signals may include a request to establish a session. Although not shown, transmitting such a request over path 110 may result in exchanges and forwarding of additional control messages between various network components.

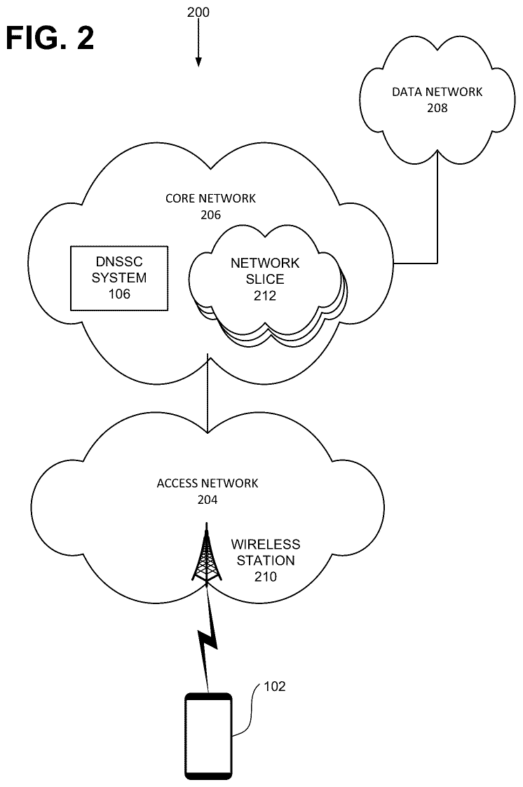

As further shown, DNSSC system 106 may include a Network Exposure Function (NEF) 310, a Service-to-Slice Map (SSM) 312, a slice management component 112, and user data component 114. These components will be described in greater detail with reference to FIGS. 2-6. With reference to FIG. 1, when NEF 310 receives request 108 from NF service consumer 104, NEF 310 queries SSM 312 to determine if SSM 312 has a record that identifies a network slice for the session requested by UE 102. If there is no such record, NEF 312 initiates a creation of the network slice, associates the network slice with the service profile, and stores the association on SSM 312. In addition, NEF 312 may send the same message regarding the service [rpfo;e to slice management 112. If there is a record, NEF 312 obtains the associated S-NSSAI, which is the identifier for the network slice. In either case, NEF 312 then accesses the user data 114 to ensure that the user data 114 includes the S-NSSAI as part of the subscriber data for the UE 102. Details of DNSSC system 106 and methods associated with DNSSC system 106 are described in greater detail below.

Dynamic network slice subscription and creation, supported by DNSSC system 106, may occur in many situations. For example, assume that UE 102 switches its profile to connect to an enterprise network slice for security reasons. In this scenario, DNSSC system 106 may dynamically trigger the creation of the enterprise network slice, if not already provisioned in the network

In another example, DNSSC system 106 may allow application servers to have UEs 102 access services provided only by a dedicated network slice that fits the service profile specified by the application servers. If the UE 102 is not subscribed to the network slice, DNSSC system 106 updates the subscription data (stored in user data 114), to add the S-NSSAI for the network slice to the subscription data. If the network slice does not yet exist, DNSSC system 106 may create the network slice and add the S-NSSAI of the created network slice to the subscription data. Once the subscription data is updated with the S-NSSAI, UE 102 may access the network slice to receive the services.

FIG. 2 illustrates an exemplary network environment 200 in which DNSSC system 106 and methods associated with DNSSC system 106 may be implemented. As shown, network environment 200 may include one or more of UE 102, an access network 204, a core network 206, and a data network 208. UE 102 may include a wireless communication device. Examples of UE 102 include: a smart phone; a tablet device; a wearable computer device (e.g., a smart watch); a global positioning system (GPS) device; a laptop computer; a media playing device; a portable gaming system; an Internet-of-Things (IoT) device. In some implementations, UE 102 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices.

Access network 204 may allow UE 102 to access core network 206. To do so, access network 204 may establish and maintain, with participation from UE 102, an over-the-air channel with UE 102; and maintain backhaul channels with core network 206. Access network 204 may relay information through these channels, from UE 102 to core network 206 and vice versa. Access network 204 may include a Long-term Evolution (LTE) radio network and/or a Fifth Generation (5G) radio network or other advanced radio network. These networks may include many central units (CUs), distributed units (DUs), radio units (RUs), and wireless stations, one of which is illustrated in FIG. 2 as a wireless station 210 for establishing and maintaining an over-the-air channel with UE 102. Wireless station 210 may include a 4G, 5G, or another type of base station (e.g., eNB, gNB, etc.) that comprise one or more radio frequency (RF) transceivers. In some implementations, wireless station 210 may be part of an evolved Universal Mobile Telecommunications Service (UMTS) Terrestrial Network (eUTRAN).

Core network 206 may include a local area network (LAN), a wide area network (WAN), a metropolitan area network (MAN), an optical network, a cable television network, a satellite network, a wireless network (e.g., a CDMA network, a general packet radio service (GPRS) network, an LTE network (e.g., 4th Generation (4G) core network), a 5G core network, an ad hoc network, a telephone network (e.g., the Public Switched Telephone Network (PSTN), an intranet, or a combination of networks. Core network 206 may allow the delivery of Internet Protocol (IP) services to UE 102, and may interface with other external networks, such as a data network 210. Core network 206 may include or be connected to one or more packet data networks.

As shown, core network 206 may include one or more of DNSSC system 106 and/or network slices 212. As briefly described above, DNSSC system 106 may provide dynamic network slice subscription and creation mechanisms. Additional details are provided below. Although network slices 212 are illustrated as residing within core network 206, network slices 212 may be implemented within other networks, such as access network 204 and/or data network 208. For example, in one implementation, a network slice 212 may be end-to-=end (E2E) and may encompass access network 204 and core network 206 (this configuration is not shown). That is, access network 204, core network 206, and data network 208 may include multiple instances of network slices 212.

Network slices 212 may be instantiated as a result of “network slicing,” which involves a form of virtual network architecture that enables multiple logical networks to be implemented on top of a shared physical network infrastructure using software defined networking (SDN) and/or network function virtualization (NFV). Each logical network, referred to as a “network slice,” may encompass an end-to-end virtual network with dedicated or shared computational resources (e.g., storage, processors, etc.) that include core network components, access network components, clouds, transport, Central Processing Unit (CPU) cycles, memory, etc. Furthermore, each network slice may be configured to meet a different set of requirements and be associated with a particular Quality of Service (QoS) class, a type of service, and/or a particular group of enterprise customers associated with fixed wireless access (FWA) devices and/or mobile communication devices.

Depending on the architecture, some network slices 212 may be created dynamically or pre-allocated for particular uses and services. In some implementations, an application or application function (AF) in core network 206, data network 208, or an edge network (e.g., network at the edge of access network 204) may sponsor a particular network slice, data on the network slice, and/or a network service. Each network slice 212 may be associated with an identifier, herein referred to as a Single Network Slice Selection Assistance Information (S-NSSAI). For each UE 102 that wishes to access a particular network slice 212, the subscription data for the UE 102 (stored in core network 206, for example), needs to include the corresponding S-NSSAI that identifies the network slice.

Data network 208 may include different types of data networks, such as a packet data network. An example of a packet data network includes an Internet Multimedia Subsystem (IMS) network, which may provide video, Voice-over-TP (VoIP), text, or other types of media services.

Depending on the implementation, network environment 200 may include additional networks and components than those illustrated in FIG. 2. However, for simplicity, FIG. 2 does not show all components that may be included in network environment 200 (e.g., routers, bridges, wireless access point, additional UE devices, switches, etc.).

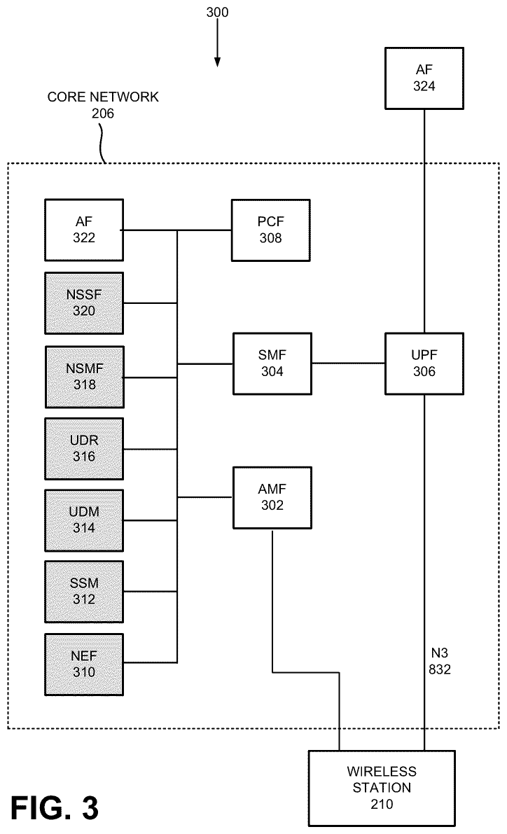

FIG. 3 depicts exemplary components of a portion 300 of network environment 200 according to an implementation. As shown, portion 300 may include wireless station 210, an application function (AF) 324, and a portion of core network 206. Wireless station 210 has been described above with reference to FIG. 2. AF 324 is one of what are referred to as network functions (NFs). AF 324 may provide an application function that belongs to a third party (i.e., an entity different from a service provider) and provides services to UEs 102 via access network 204, core network 206, and/or data network 208. In one implementation, AF 324 may operate as the NF service consumer 104 depicted in FIG. 1. When UE 102 connects to AF 324 in network environment 200, AF 324 may send a message to an NF within core network 206 (e.g., NEF 310). For example, AF 324 may signal a session to NEF 310.

In FIG. 3, core network 206 comprises, in addition to other components described with reference to FIG. 2, multiple NFs that are implemented in accordance with Service Based Architecture (SBA), either as physical devices or virtual components (e.g., a container or a virtual machine). Each NF includes a particular network functionality and may act as an NF service consumer or an NF service producer. An NF service consumer receives services from a NF service producer, which provides services to other NFs.

As further shown, the NFs in core network 206 include: an Access and Mobility Management Function (AMF) 302, a Session Management Function (SMF) 304, a User Plane Function (UPF) 306, a Policy Control Function (PCF) 308, a Network Exposure Function (NEF) 310, a Slice-to-Service Map (SSM) 312, a Unified Data Management (UDM) 314, a Unified Data Repository (UDR) 316, a Network Slice Management Function (NSMF) 318, a Network Slice Selection Function (NSSF) 320, and an AF 322. NFs 302-310 and 314-322 are 5G core network functions. In FIG. 3, the shaded components 310-320 belong to or are also included in DNSSC system 106. That is, NFs 310 and 314-320 may be included in or belong to both DNSSC system 106 core network 206. SSM 312 belongs to DNSSC system 106. Depending on the implementation, core network 206 and DNSSC system 106 may include additional, fewer, and/or different components than those illustrated in FIG. 3.

AMF 302 may perform registration management, connection management, reachability management, mobility management, lawful intercepts, Short Message Service (SMS) transport between UE 102 and an SMS function, session management message transport between UE 102 and SMF 304, access authentication and authorization, location services management, support of non-3GPP access networks, and/or other types of management processes. AMF 302 may page UE 102 based on mobility category information associated with UE 102 obtained from UDM 314. In some implementations, AMF 302 may implement some or all of the functionality of managing RAN slices in wireless station 210.

SMF 304 may: perform session establishment, modification and/or release; perform IP address allocation and management; perform Dynamic Host Configuration Protocol (DHCP) functions; perform selection and control of UPF 306; configure traffic steering at UPF 306 to guide traffic to the correct destination; terminate interfaces toward PCF 322; perform lawful intercepts; charge data collection; support charging interfaces; control and coordinate charging data collection; terminate session management parts of Non-Access Stratum (NAS) messages; perform downlink data notification; manage roaming functionality; and/or perform other types of control plane processes for managing user plane data.

UPF 306 may perform the following: maintain an anchor point for intra/inter-RAT mobility (e.g., mobility across different radio access technologies; maintain an external Packet Data Unit (PDU) point of interconnect to a data network (e.g., an IP network, etc.); perform packet routing and forwarding; perform the user plane part of policy rule enforcement; perform packet inspection; perform lawful intercept; perform traffic usage reporting; perform Quality-of-Service (QoS) handling in the user plane; perform uplink traffic verification; perform transport level packet marking; perform downlink packet buffering; send and forwarding an “end marker” to a Radio Access Network node (e.g., wireless station 210); and/or perform other types of user plane processes.

PCF 308 may support policies to control network behavior, provide policy rules to control plane functions (e.g., to SMF 304), access subscription information relevant to policy decisions, perform policy decisions, and/or perform other types of processes associated with policy enforcement.

NEF 310 may expose capabilities and events to other NFs, including third party NFs AFs, edge computing NFs, and/or other types of NFs. Furthermore, NEF 310 may secure provisioning of information from external applications to data network 208, translate information between core network 206 and devices/networks external to access network 204, support a Packet Flow Description (PFD) function, and/or perform other types of network exposure functions.

SSM 312 may store associations between a particular service (or a service profile) and a network slice (or S-NSSAI). SSM 312 may receive queries requesting SSM 312 to provide an S-NSSAI for a network slice corresponding to a service and provide the S-NSSAI, if available. In addition, SSM 312 may receive a request from NEF 302 to associate an S-NSSAI to a network slice and store the association. SSM 312 may include either a virtual component or a hardware component that is separate from UDM 314. Depending on the implementation, SSM 312 is needed to store the service-to-slice map because the service-to-slice map includes non-subscription data that may not be stored by UDM 314 and/or UDR 316.

UDM 314 may: maintain subscription information for UE 102; manage subscriptions; generate authentication credentials; handle user identification; perform access authorization based on subscription data; perform network function registration management; maintain service and/or session continuity by maintaining assignment of SMF 304 for ongoing sessions; support SMS delivery, support lawful intercept functionality; and/or perform other processes associated with managing user data. For example, UDM 314 may store subscription profiles that include authentication, access, and/or authorization information. Each subscription profile may include: information identifying UE 102; authentication and/or authorization information for UE 102; information identifying services enabled and/or authorized for UE 102; device group membership information for UE 102; and/or other types of information associated with UE 102. Furthermore, the subscription profile may include mobility category information associated with UE 102.

UDR 316 may store subscriber/subscription data (e.g., subscriber/subscription profile) associated with UEs 102, modify subscriber data, and/or delete subscriber data. In many implementations, UDM 314 and UDR 316 may not store non-subscription data. For example, UDM 314 and UDR 316 may not store service-to-slice map that SSM 312 stores.

NSMF 318 may manage network slices 212. The management may include instantiation, removal, and/or modification of network slices based on specifications and/or service profiles. If NSMF 318 creates a network slice, NSMF 318 may obtain a S-NSSAI for the network slice and store the S-NSSAI at NSSF 320. NSSF 320 may select a set of network slice instances to serve a particular UE 102, determine NSSAI, determine a particular AMF 302 to serve a particular UE 102, and/or perform other types of processes associated with network slice selection or management.

AF 322 may provide services associated with a particular application, such as, for example, application on traffic routing, accessing NEF 310, interacting with a policy framework for policy control, and/or other types of applications. In contrast to AF 324, AF 322 may belong to the provider network and may be included in core network 206.

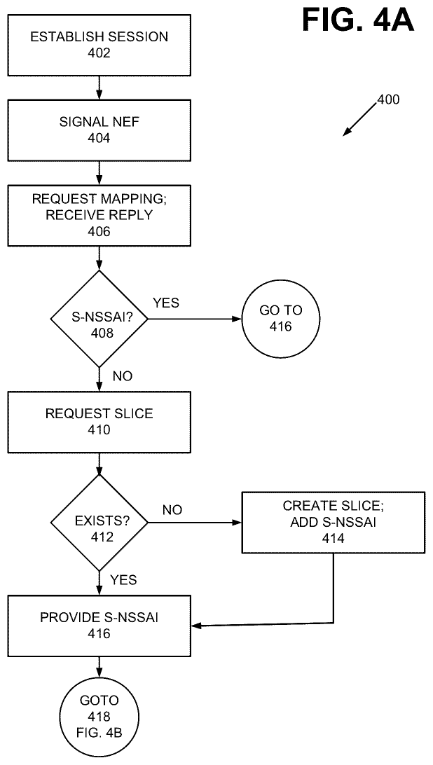

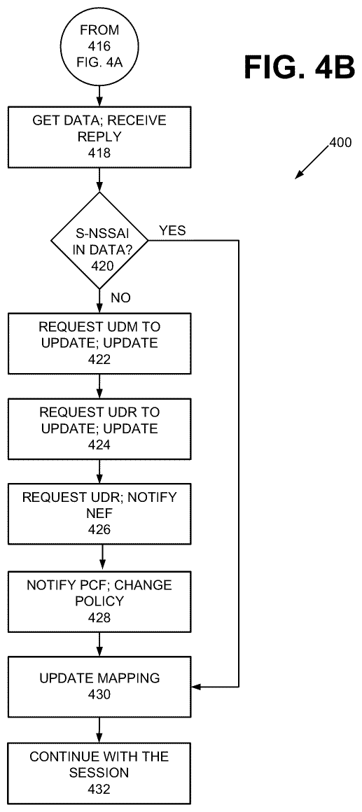

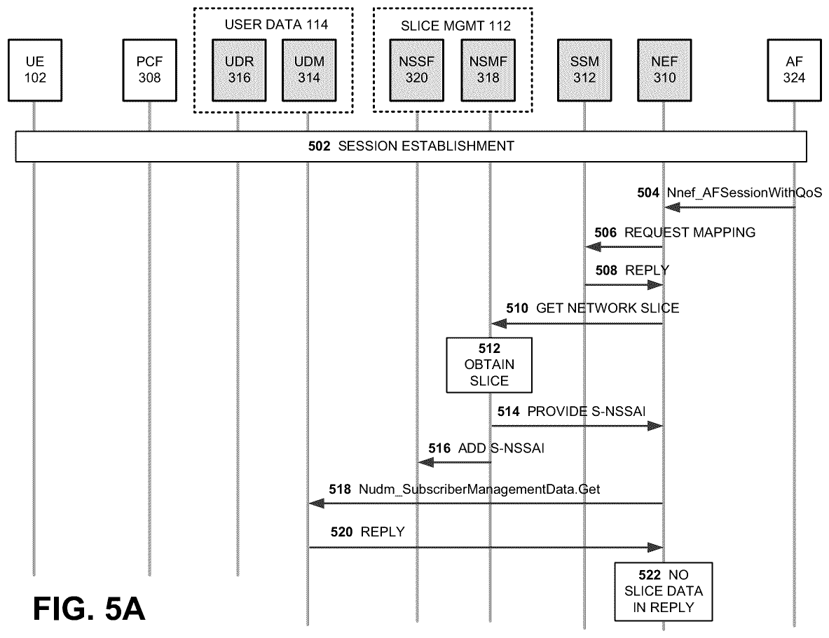

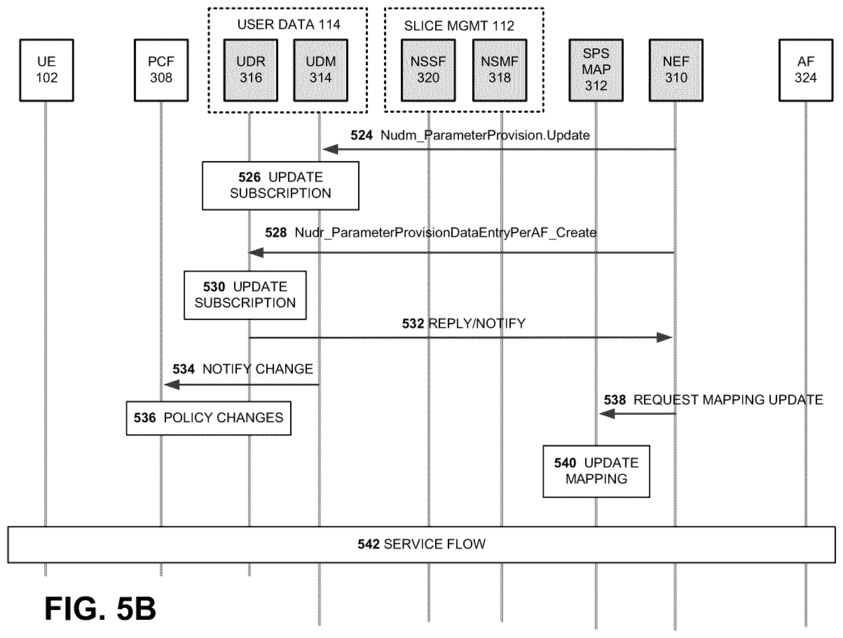

In addition to the functionalities described above, the components 302-324 may include additional capabilities. Such capabilities may be implemented through modification of standard interfaces and/or addition of new interfaces for interacting with various functions. Some of these additional capabilities for supporting dynamic network slice subscription and creation are described below with reference to FIGS. 4A, 4B, 5A, and 5B.

FIGS. 4A and 4B show a flow diagram of an exemplary process 400 that is associated with the systems and methods for supporting dynamic network slice subscription and creation, according to an implementation. FIGS. 5A and 5B show a signaling diagram associated with process 400 and are described below along with process 400. Process 400 may be performed by one or more components 302-324, also shown in FIGS. 5A and 5B. Although additional network components may perform part of process 400, these components are not shown in FIGS. 5A and 5B. Also, FIGS. 5A and 5B are not intended illustrate every signal/message exchanged or tasks performed by the network components during process 400.

As shown, process 400 may include UE 102 establishing a session with an application function 324 over a wireless network (e.g., access network 204, core network, and/or data network 208) (block 402 and 502). UE 102 and AF 324 may or may not have completed the session establishment, when AF 324 signals NEF 310 (block 404). The signaling may be in the form of a call via an interface (e.g., Nnef_AFSessionWithQoSCreate) (arrow 504). The call may provide a number of parameter values (e.g., AF identifier, a UE address, a UE IP address, a flow description, QoS reference, QoS parameters, a Requested QoS, etc.) to NEF 310.

In response to the call, NEF 310 may request a service-to-slice mapping from SSM 312 (block 406 and arrow 506) via a new interface. The request for the service-to-slice mapping (also referred to as Service profile-to-S-NSSAI mapping) request may include QoS parameters, flow descriptors, UE identifiers, an application ID, etc. When SSM 312 receives the service-to-slice mapping request, SSM 312 may determine whether an S-NSSAI corresponding to the service (or the service profile) exists in its database (block 408) and a forward a reply to NEF 310 indicating whether the S-NSSAI exists (arrow 508). If the reply indicates that the S-NSSAI exists (block 408: yes), process 400 may proceed to block 416. Otherwise (block 408: no), process 400 may proceed to block 410, where NEF 310 forwards a request to NSMF 318 to instantiate a network slice corresponding to the service/service profile (block 410; arrow 510).

At block 412, in response to the request for the network slice, NSMF 318 finds an S-NSSAI that meets the requirements of the service profile (block 412: yes), NSMF 318 may provide the S-NSSAI to NEF 310 (block 416; arrow 514). If NSMF 318 determines that none of the existing S-NSSAI matches the service profile (block 412: no), NSMF 318 may create/instantiate the corresponding network slice (block 414: block 512). Next, NSFM 318 may forward the S-NSSAI for the network slice to NEF 310 (arrow 514) and request NSSF 320 to add the S-NSSAI for the service profile to its database of S-NSSAIs and service profiles (arrow 516).

Process 400 may further include NEF 310 requesting information from UDM 314 (block 418). For example, NEF 310 may make the request via the interface referred to as Nudm_SubsuscriberManagementDataGet interface (arrow 518). The request may be for, for example, slice selection subscription data, some subscription data, mobility data, session management subscription data, NSSAI, etc. In response to the request UDM 314 may provide the requested information (block 418; arrow 520). The information may indicate whether the UE 102 is subscribed to the S-NSSAI.

Process 400 may further include NEF 310 determining whether the data in the reply from UDM 314 includes the S-NSSAI (block 420). More particularly, NEF 310 may determine whether the NSSAI (which is a list of S-NSSAIs for the network slices to which the UE has access or can connect to) includes the S-NSSAI. If the data includes the S-NSSAI (block 420: yes), NEF 310 may request SSM 312 to update its database of service-to-slice, so that the database includes the association between the S-NSSAI and the service profile (block 430). If the data does not include the S-NSSAI (block 420: no; block 522), NEF 310 may request UDM 314, via a modified interface to add the S-NSSAI to the list of S-NSSAIs to which the UE 102 can connect (block 422). The modified call interface may include, for example, Nudm_ParameterProvisionUpdate (block 524), with the S-NSSAI as one of the arguments. In response to the request, UDM 314 may initiate updating the subscription data (block 422; block 526). To update the subscription data, UDM 314 may invoke an update request to UDR 316 where the subscription data from the UE 102 is stored, providing the S-NSSAI in the request.

Process 400 may further include NEF 310 making a call to UDR 316 to update parameters pertaining to AF 324 (block 426; arrow 528). The call may include invoking the call interface ParameterProvisionDataEntryPerAF_Create. The call may be made with one of more of the following parameters: packet flow descriptors, AF traffic influence information, AF transaction ID, S-NSSAI (for the network slice with the requested service), a data network name (DNN), etc. In response to the request, UDR 316 may update its database regarding the data associated with the AF (block 530), notify changes to NEF 310 (block 426; arrow 532).

Process 400 may further include UDM 314 requesting PCF 308 about the change in the subscription data (block 428; arrow 534). In response to the notification, PCF 308 may make policy changes in accordance with the update (block 428. block 536).

Process 400 may further include sending SSM 312 a request to update its database of the association between S-NSSAIs and service profiles (block 430; arrow 538). More specifically, NEF 310 may request SSM 312 to store the association between the S-NSSAI for the network slice and the corresponding service. In response to the request, SSM 312 may update the database/mapping (block 430; block 540). Thereafter, NEF 310 may provide a response to the original request from AF 324 to create a session with the specified QoS. AF 324 and the network slice may provide the service to the UE 102—continue with the session with the UE 102 and provide the eservice flow (block 432 and arrow 542).

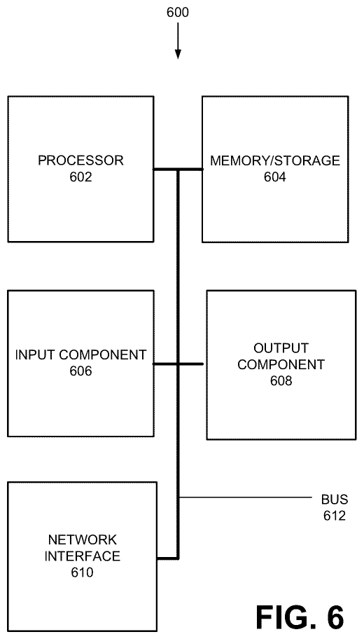

FIG. 6 depicts exemplary components of an exemplary network device 600. Network device 600 may correspond to or be included in any of the devices and/or components illustrated in FIGS. 1-3, 4A, 4B, 5A, and 5B (e.g., UE 102, access network 204, core network 206, data network 208, DNSSC system 106, NFs 302-310, 314-324, SSM 312, etc.). In some implementations, network devices 600 may be part of a hardware network layer on top of which other network layers and NFs may be implemented.

As shown, network device 600 may include a processor 602, memory/storage 604, input component 606, output component 608, network interface 610, and communication path 612. In different implementations, network device 600 may include additional, fewer, different, or different arrangement of components than the ones illustrated in FIG. 6. For example, network device 600 may include line cards, switch fabrics, modems, etc.

Processor 602 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 600 and/or executing programs/instructions.

Memory/storage 604 may include static memory, such as read only memory (ROM), and/or dynamic memory, such as random access memory (RAM), or onboard cache, for storing data and machine-readable instructions (e.g., programs, scripts, etc.).

Memory/storage 604 may also include a floppy disk, CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 604 may be external to and/or removable from network device 600. Memory/storage 604 may include, for example, a Universal Serial Bus (USB) memory stick, a dongle, a hard disk, off-line storage, a Blu-Ray® disk (BD), etc. Memory/storage 604 may also include devices that can function both as a RAM-like component or persistent storage, such as Intel® Optane memories.

Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 606 and output component 608 may provide input and output from/to a user to/from network device 600. Input/output components 606 and 608 may include a display screen, a keyboard, a mouse, a speaker, a microphone, a camera, a DVD reader, USB lines, and/or other types of components for obtaining, from physical events or phenomena, to and/or from signals that pertain to network device 600.

Network interface 610 may include a transceiver (e.g., a transmitter and a receiver) for network device 600 to communicate with other devices and/or systems. For example, via network interface 610, network device 600 may communicate over a network, such as the Internet, an intranet, a terrestrial wireless network (e.g., a WLAN, WiFi, WiMax, etc.), a satellite-based network, optical network, etc. Network interface 610 may include a modem, an Ethernet interface to a LAN, and/or an interface/connection for connecting network device 600 to other devices (e.g., a Bluetooth interface).

Communication path 612 may provide an interface through which components of network device 600 can communicate with one another.

Network device 600 may perform the operations described herein in response to processor 602 executing software instructions stored in a non-transient computer-readable medium, such as memory/storage 604. The software instructions may be read into memory/storage 604 from another computer-readable medium or from another device via network interface 610. The software instructions stored in memory/storage 604, when executed by processor 602, may cause processor 602 to perform processes that are described herein.

For example, to implement NFs as described above, the network device 600 may execute computer instructions that correspond to the NFs described above. In another example, when a NEF 310 stores ab association between an S-NSSAI and a service at SSM 312 or when an NFqueries the SSM 312 for an S-NSSAI corresponding to a network service, network devices 600 may execute computer instructions that correspond to NEF 310 storing the association at SSM 312 and querying for the S-NSSAI at SSM 312.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while a series of blocks and signals have been described with regard to the processes and signal flows illustrated in FIGS. 4A, 4B, 5A, and 5B, the order of the blocks and signaling may be modified in other implementations. In addition, non-dependent blocks and signals may represent acts and signals that can be performed in parallel and in different order.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor configured to:
receive a request from a network function to establish a session for the network function and a User Equipment device (UE);
obtain an identifier corresponding to a network slice for providing the session; and
establish the session, for the network function between the UE and the network slice.

2. The device of claim 1, wherein the network function comprises an Application Function (AF) and the device comprises a Network Exposure Function (NEF).

3. The device of claim 1, wherein when the processor obtains the identifier, the processor is further configured to:
determine whether a network slice that corresponds to a service profile for the session exists by using a mapping between services and network slices; and
perform one of:
when the processor determines that the network slice exists, obtain the identifier from the mapping; or
when the processor determines that the network slice does not exist, request a Network Slice Management Function (NSMF) to create the network slice.

4. The device of claim 3, wherein the mapping is stored in a network component, and wherein the network component does not include a Unified Data Management (UDM) or a Unified Data Repository (UDR).

5. The device of claim 1, wherein the processor is further configured to:
request a second network function to store the identifier in subscription data associated with the UE.

6. The device of claim 5, wherein the second network function comprises a Unified Data Management (UDM), and wherein the UDM is configured to request a Unified Data Repository (UDR) to add the identifier to the subscription data for the UE.

7. The device of claim 6, wherein the UDM is further configured to:
notify a Policy Control Function (PCF) that the identifier has been added to the subscription data.

8. The device of claim 5, wherein the processor is further configured to:
request a Unified Data Repository (UDR) to enter the identifier for the network function, and wherein the network function includes an Application Function (AF).

9. A method comprising:
receiving a request from a network function to establish a session for the network function and a User Equipment device (UE);
obtaining an identifier corresponding to a network slice for providing the session; and
establishing the session, for the network function between the UE and the network slice.

10. The method of claim 9, wherein the network function comprises an Application Function (AF).

11. The method of claim 9, wherein obtaining the identifier comprises:
determining whether a network slice that corresponds to a service profile for the session exists by using a mapping between services and network slices; and
when the network slice is determined to exist, obtaining the identifier from the mapping; or
when the network slice is determined to not exist, requesting a Network Slice Management Function (NSMF) to create the network slice.

12. The method of claim 11, therein the mapping is stored in a network component, and wherein the network component does not include a Unified Data Management (UDM) or a Unified Data Repository (UDR).

13. The method of claim 9, further comprising:
requesting a second network function to store the identifier in subscription data associated with the UE.

14. The method of claim 13, wherein the second network function comprises a Unified Data Management (UDM), and wherein the UDM is configured to request a Unified Data Repository (UDR) to add the identifier to the subscription data for the UE.

15. The method of claim 14, wherein the UDM is further configured to:
notify a Policy Control Function (PCF) that the identifier has been added to the subscription data.

16. The method of claim 13, further comprising:
requesting a Unified Data Repository (UDR) to enter the identifier for the network function, wherein the network function includes an Application Function (AF).

17. A non-transitory computer-readable medium comprising processor-executable instructions, which when executed by a processor configures the processor to:
receive a request from a network function to establish a session for the network function and a User Equipment device (UE);
obtain an identifier corresponding to a network slice for providing the session; and
establish the session, for the network function, between the UE and the network slice.

18. The non-transitory computer-readable medium of claim 17, wherein the network function comprises an Application Function (AF).

19. The non-transitory computer-readable medium of claim 17, when the processor obtains the identifier, the processor is further configured to:
determine whether a network slice that corresponds to a service profile for the session exists by using a mapping between services and network slices; and
perform one of:
when the processor determines that the network slice exists, obtain the identifier from the mapping; or
when the processor determines that the network slice does not exist, request a Network Slice Management Function (NSMF) to create the network slice.

20. The non-transitory computer-readable medium of claim 19, therein the mapping is stored in a network component, and wherein the network component does not include a Unified Data Management (UDM) or a Unified Data Repository (UDR).
